(19) United States
(12) Patent Application Publication
(10) Pub. No.: US 2020/0324967 A1
(43) Pub. Date: Oct. 15, 2020

(54) CARBON FOOTPRINT REDUCING RESIDENTIAL GARBAGE OR RECYCLING TRUCKS

(71) Applicant: Andrew D. Bickle, Janesville, WI (US)

(72) Inventor: Andrew D. Bickle, Janesville, WI (US)

(21) Appl. No.: 16/835,753

(22) Filed: Mar. 31, 2020

Related U.S. Application Data
(60) Provisional application No. 62/833,859, filed on Apr. 15, 2019.

(51) Int. Cl. B65F 3/24; B65F 3/20; B65F 3/02

(52) U.S. Cl. CPC B65F 3/24; B65F 2003/008; B65F 3/02; B65F 3/205

(57) ABSTRACT

A residential side loading garbage or recycling truck is provided which is equipped with an easily removable roll off disposal container which can be easily replaced to reduce man hours and travel time spent in the collection of trash or recyclables and to reduce the carbon footprint per truck because of the reduction in fuel used. The foregoing features are provided by equipping the truck with a compacting unit that remains with the truck at all times and a number of disposal containers located at predetermined locations so that once one disposal container is filled, the truck is driven to one of those locations and filled disposal container is replaced with an empty disposal container so that the truck may return to its route without the need to travel to a garbage or recycling center.

### CROSS-REFERENCE TO RELATED APPLICATION

This application claims the benefit of U.S. Provisional Application No. 62/833,859 filed Apr. 15, 2019 and hereby incorporates the entire disclosure of that application by reference.

### FEDERALLY SPONSORED RESEARCH OR DEVELOPMENT

Not Applicable.

### BACKGROUND THE INVENTION

There are a variety of residential and commercial disposal trucks in use today. As described in U.S. Pat. No. 7,997,852, there are five common garbage trucks, namely, a front loader, a rear loader, a side loader, recycling trucks and roll off trucks. The present invention deals with an improved residential side loading garbage or recycling truck equipped with a roll off disposal container that is easily removed and replaced resulting in reduced man hours spent in the collection of trash or recyclables, reduced travel time and a reduced carbon footprint per truck because of the reduced fuel used.

### SUMMARY OF THE INVENTION

In the present invention, the disposal truck is provided with a roll off disposal container that can be easily removed when it is filled during collection and easily replaced with an empty container along the collection route without the need to travel to the garbage dump or recycling center to unload and then return back to resume the route. It is contemplated that the filled containers will be removed from a truck at a predetermined location so that filled containers from multiple trucks could be loaded on a flatbed and then transported and emptied at a dump or recycling center. The use of multiple trucks with easily removed and replaced roll off containers would present an improvement especially in residential areas by allowing more man hours to be dedicated to collection and reducing the carbon footprint per truck by reducing the amount of fuel consumed.

In the present invention, the disposal truck is a side loading truck which includes a compacting unit that is separate from the disposal container and remains with the truck at all times. The assembly of a disposal container with a compacting unit on the truck for use in collecting or recycling materials is accomplished by using dual cut off blades, hydraulic quick connects, ratchet binders and liquid drip edges which improve the ease and speed of removing and replacing the disposal container as well as the cleanliness of that process. All of the foregoing is accomplished with the disposal truck assembly of the present invention.

In short, the present invention is an economical disposal truck which is an improvement over known trucks in that it provides a truck in which the container for garbage or recyclable materials can be easily removed and replaced when full and without the need to make multiple trips to the dump or recycling center reducing man hours and the carbon footprint per truck as a result of reduced consumption of fuel.

### BRIEF DESCRIPTION OF THE DRAWINGS

FIG. 1 is a side view of the disposal truck of the present invention.

FIG. 2 is a side view of a portion of the disposal truck of the present invention illustrating how the disposal container and compacting unit are mated or joined together for the collection of trash or recyclables.

FIG. 3 is a side view of a portion of the disposal truck of the present invention showing a portion of the disposal container and a cutaway view of the compacting unit with the arrangement of the compacting blade in the compacting unit.

FIG. 4 is a side view of a portion of the disposal truck of the present invention illustrating one method of fastening the disposal container and compacting unit are joined together for the collection of trash or recyclables.

FIG. 5 is a front view of the disposal container of the present invention where it mates with the compacting unit of the disposal truck of the present invention for the collection of trash or recyclables.

FIG. 6 is a side view of the disposal truck of the present invention illustrating the disposal of trash from the disposal container when it is still attached to the truck.

FIG. 7 is a side view of the rear chassis of the disposal truck of the present invention in which the roll off frame attached to the chassis in an elevated position.

FIG. 7A is a top view of the roll off frame of FIG. 6B.

FIG. 8 is a side view of the disposal truck of the present invention illustrating the removal of the disposal container from the rest of the truck using the roll frame of FIG. 6B when the container is full or needs to be removed.

FIG. 9 is a side view of the disposal truck of the present invention illustrating another method of removing the disposal container from the rest of the truck when the container is full or needs to be removed.

FIG. 10 is a side view of the disposal container of the disposal truck of the present invention separated from the truck.

### DETAILED DESCRIPTION OF THE PREFERRED EMBODIMENT

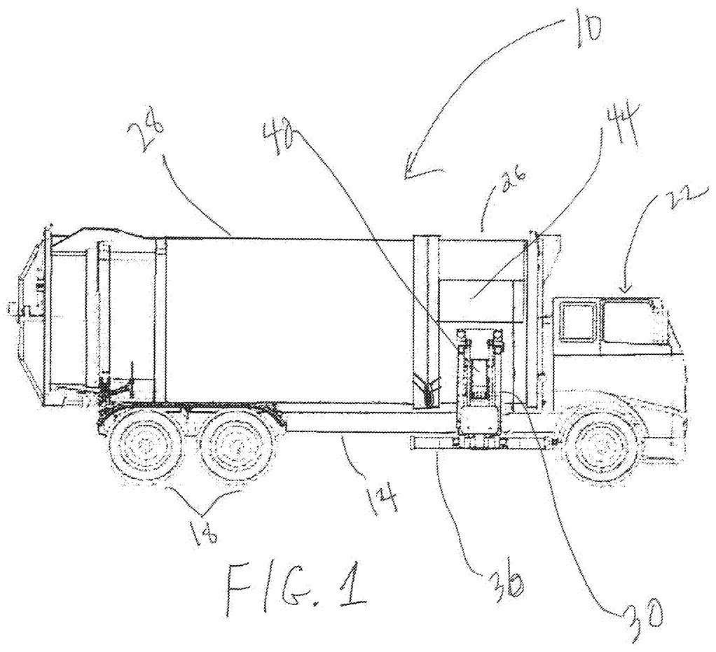

The disposal truck of the present invention is depicted generally in FIG. 1. The disposal truck 10 has a chassis 14 carried on wheels 18 which may have a hydraulic ram and lever arrangement or a hoist and sub-frame arrangement for lifting the chassis of the truck in a dump truck like fashion. Disposal truck 10 has a cab 22 which includes a compartment for a driver which also houses the various controls for manipulating the movement of the collecting and processing features of the truck. The cab 22 also houses an engine (not shown) for powering the truck.

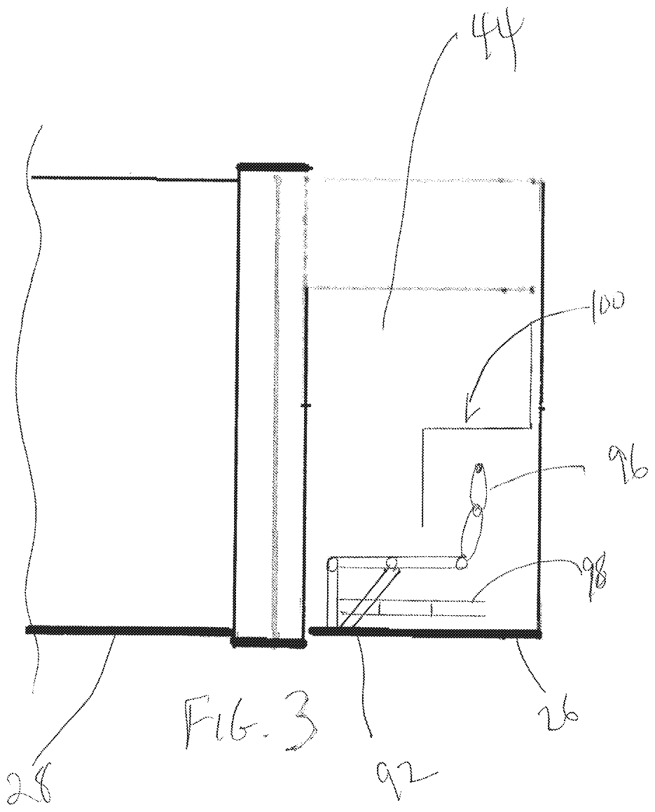

The chassis 14 carries a compacting unit 26 and a disposal or recycling container 28 which are separate structures with the compacting unit 26 being fixedly attached to the chassis 14 and the container 28 and compacting unit 26 being removably attached to each other. The compacting unit 26 has operatively attached to its side a side loading arm 30 which has a gripping mechanism 36 for gripping a trash can (or recycling bin) 40. The compacting unit 26 includes a hopper 44 and a compacting blade arrangement (shown in FIG. 3).

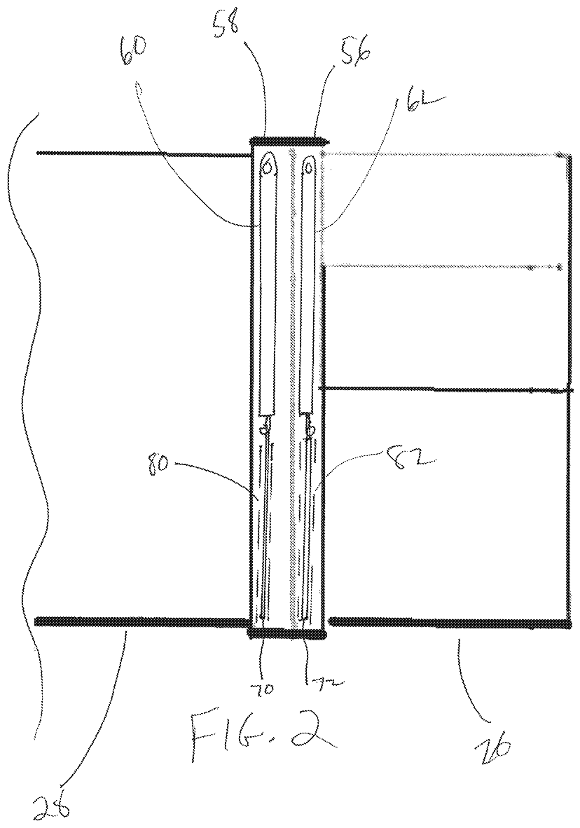

FIG. 2 is a cutaway view of the portion of the disposal truck 10 where the disposal or recycling container 28 and compacting unit 26 mate. The rear face 56 of compacting unit 26 and the front face 58 of container 28 are each provided with hydraulic cylinders 60 and 62 to which cutting blades 70 and 72 are attached. Cutting blades 70 and 72 travel up and down along tracks 80 and 82, respectively, and further compact trash and recycling materials as they travel from the hopper of compacting unit 26 into disposal container 28. When disposal container 28 is full, cutting blades 7 and 72 seal the opening of container 28 to deter leakage when container 28 is removed from the truck.

FIG. 3 shows a portion of the disposal or recycling container 28 and compacting unit 26 with a cutaway view of the hopper section 44 showing the placement of compacting blade 92 at the bottom of the hopper section. The compacting blade 92, when in use, travels along track 98. A shield 100 is provided above compacting panels 96 to channel the garbage and recycling materials dumped into hopper section 44 in the direction of the compacting blade 92. When in use, compacting blade 92 pushes the garbage or recyclable materials to disposal container 28.

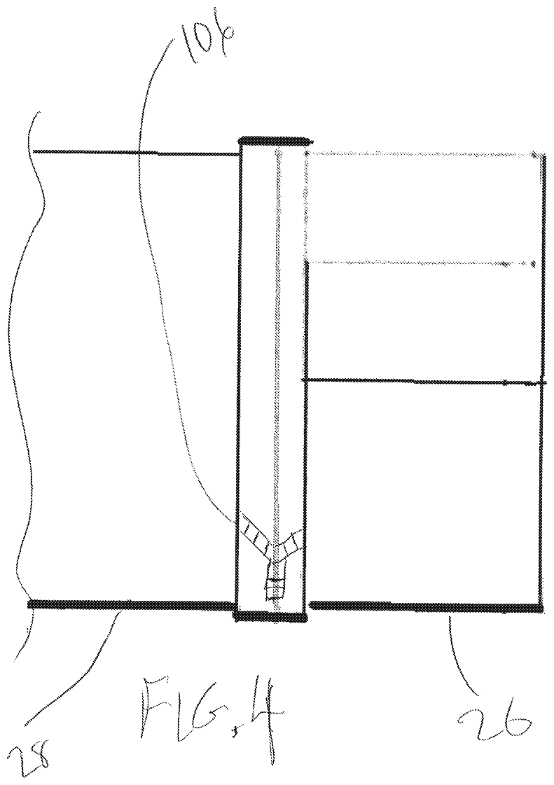

FIG. 4 shows a portion of the disposal or recycling container 28 and compacting unit 26 and one of the ways in which those two structures may be fastened together attached to each other during the garbage or recycling collection. At least two ratchet chain binders 106 (only one is shown) or other fastening structure are provided, one on each side, to connect the container 28 and unit 26 to each other so that the ends facing each other form a seal to avoid any leakage of garbage or recyclable materials during use.

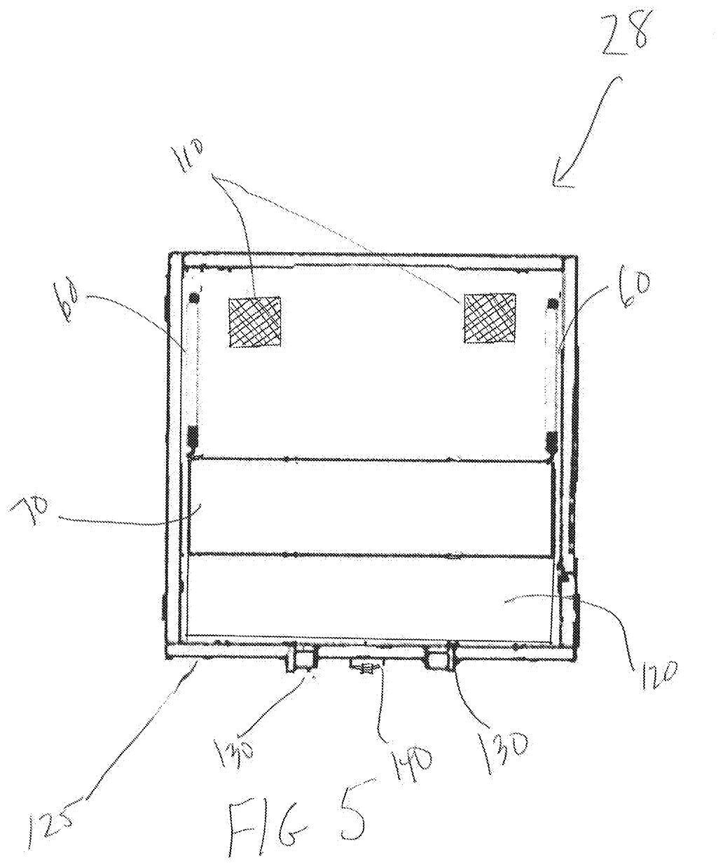

FIG. 5 shows the front view of disposal or recycling container 28 which mates with the rear portion of compacting unit 26. As explained above, container 28 is provided with a set of hydraulic cylinders 60 which are attached to cutting blade 70. When the garbage or recycling materials are pushed from hopper section 44, they are pushed into opening 120 in container 28. Controls for hydraulic cylinders 60 (which are located in the cab) are initiated and blade 70 moves up and down over opening 120 to further aid in moving the garbage or recycling materials into the interior of container 28. Container 28 also has a liquid drip edge 125 extending along its width to prevent the spillage of trash or recyclable materials when container 28 is separated from compacting unit 26. Container 28 also has sight openings, preferably covered with screens 110, to allow the operator to see how much garbage or recycling materials are in the container. Container 28 is also provided with rails 130 to keep it centered on the frame of the truck and hitching device 140 to allow for easy loading and unloading of container 28 on truck 10.

Referring to FIGS. 1 through 5, when disposal truck 10 is used to collect trash or recyclable materials, the truck pulls up to a residence so that side loading arm 30 lines up with the trash can or recycling bin to be emptied. Side loading arm 30 is activated by controls within the cab so that it grips the can or bin with gripping mechanism 36, lifts in a vertical direction and tilts the can or bin to allow the contents of to empty into hopper 44 of the compacting unit 26. As shown in FIG. 3, hopper 44 is equipped with blade 92, and when materials are dumped into hopper 44, when activated, blade 92 which push trash or recyclable materials from hopper 44 into disposal container 28. Since blade 92 travels along the floor of hopper 44, it also compacts and pushes the trash or recyclable materials through an opening 120 in the rear of compacting unit 26 where blade 72 further pushes trash or recyclable materials into an opening in the front face of the disposal container or recycle bin 28. That process repeats itself until the disposal container or recycle bin 28 is full of trash or recyclables.

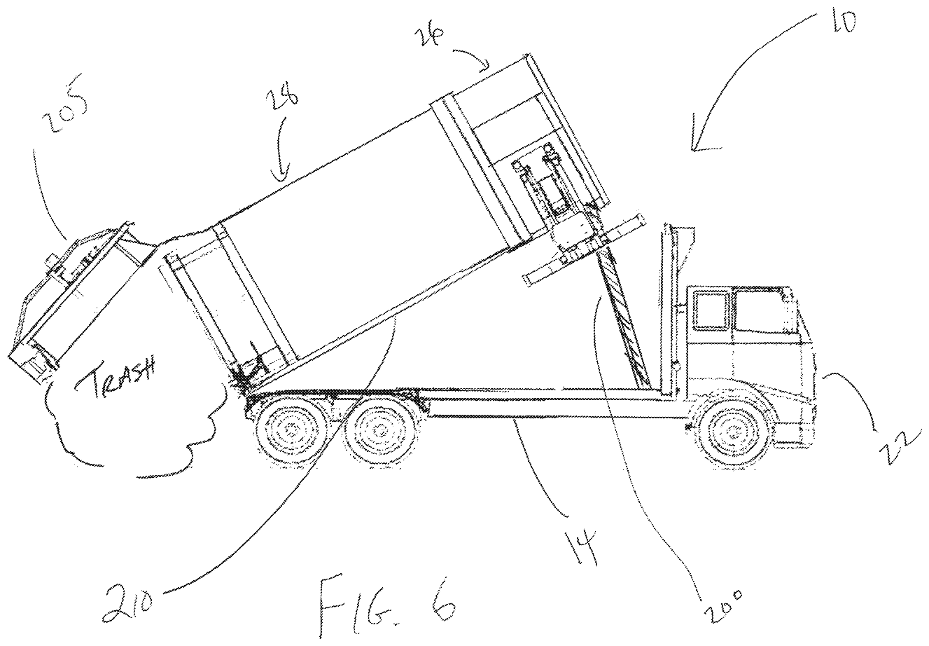

FIG. 6 shows one of the ways in which the disposal truck 10 of the present invention can be emptied when the disposal container 28 is filled with trash or recycling materials. In FIG. 6, the back door 205 of disposal container 28 is opened so that trash or recyclable materials may be emptied out of the container. The disposal container 28 and compacting unit 26 are situated on roll off frame 210 which is raised off the chassis 14 at the end closest to the cab 22 by way of hydraulic rams 200 (one of which is shown) so that the compacting unit 26 is at a higher elevation than rear end of disposal container 28. As a result of the tilting of the disposal container 28, and gravity, the trash or recyclable materials empty out of the container.

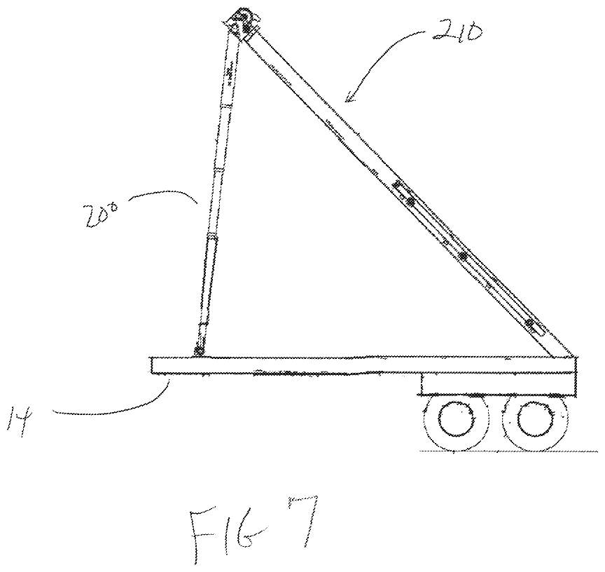

FIG. 7 illustrates one example of roll off frame 210 that is contemplated to be used in a preferred embodiment of the present invention. Roll off frame 210 is provided with a hydraulic ram and lever arrangement 200 which raises the frame 210 from the chassis 14. FIG. 7A is a top view of roll off frame 210 which has rails 250 along its length for guiding disposal container 28 and keeping it centered. A cable 252, pulley 254 and hook 256 are located down the center of the frame 210, with pulley 254 being attached to hydraulic cylinders 270 which are connected to a control source (not shown) to provide the power to drive cable 252. A roller assembly 260 is provided at the rear of frame 210 to assist in the loading and unloading of disposal container 28 from the truck.

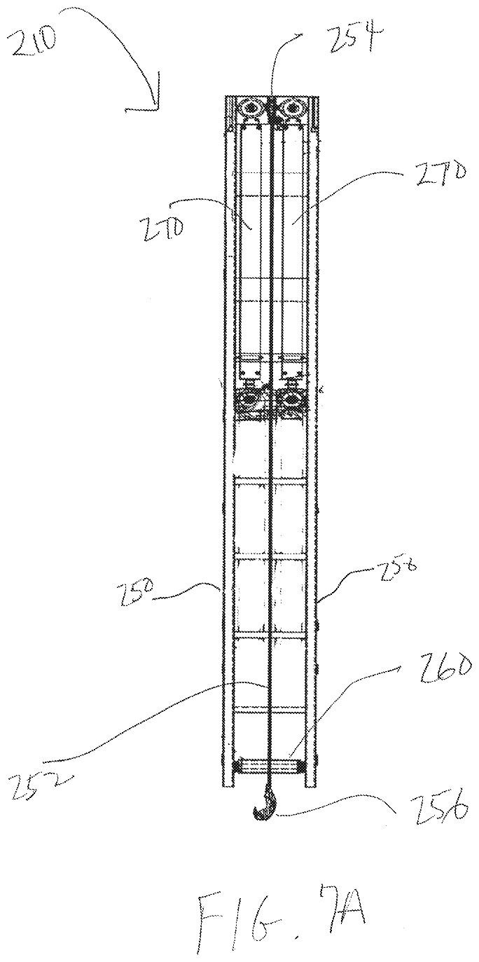

FIG. 8 illustrates the preferred way in which the disposal truck 10 of the present invention may be used. As in FIG. 7, chassis 14 is provided with a hydraulic ram and lever arrangement 200. In FIG. 8, the disposal container 28 and compacting unit 26 are no longer fastened together with ratchet chain binders (as shown in FIG. 4). Rather the cable 252 in roll off frame 210 is attached to hitching device 140 on the front face of disposal container 28 (shown in FIG. 3). When disposal container 28 is full, the hydraulic ram and lever arrangement 200 is used to raise the roll off frame 210 containing both compacting unit 26 and disposal container 28 so that compacting unit 26 is at a higher elevation than disposal container 28.

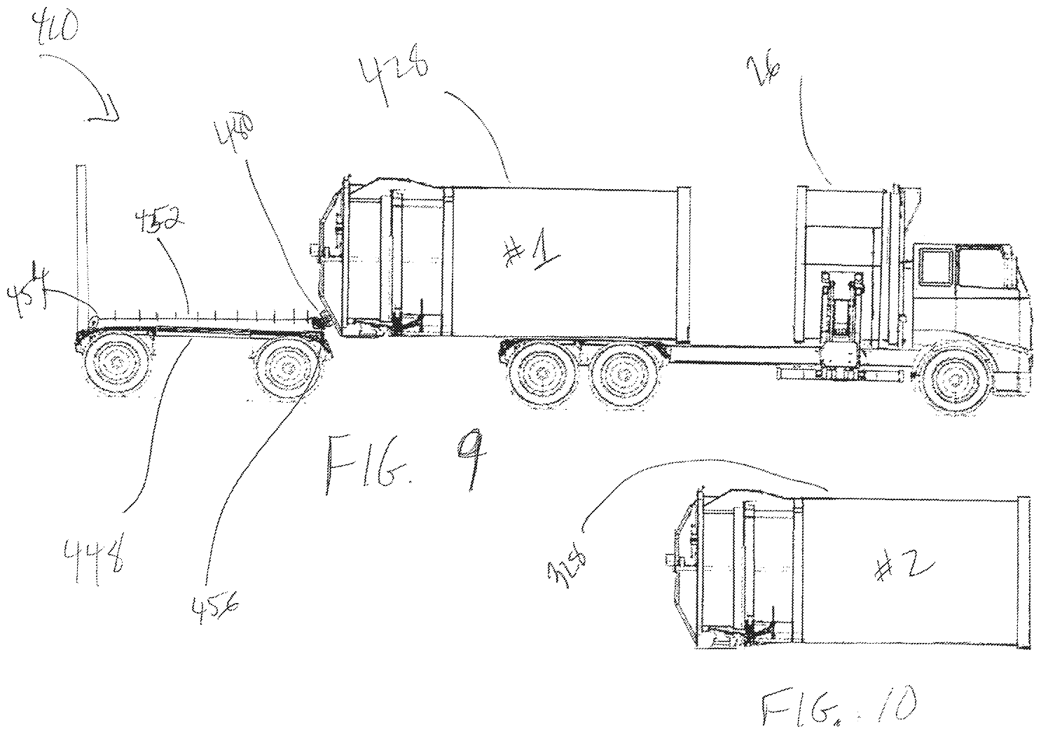

The controls for hydraulic cylinders 270 are then activated to feed cable 252 out through pulley 254 so that, by virtue of gravity, disposal container 28 slides down the raised roll off frame 210 and is then deposited on the ground. Once the full disposal container 28 is removed, the process can be reversed by attaching an empty disposal container 328 (as shown in FIG. 10 as #2) to cable 252 and retracting the cable to pull disposal container 328 onto roll off frame 210. Roll off frame 210 is then lowered with cable 252 being completely retracted and disposal container 328 and compacting unit 26 are fastened together and ready to resume collection of trash or recyclable materials.

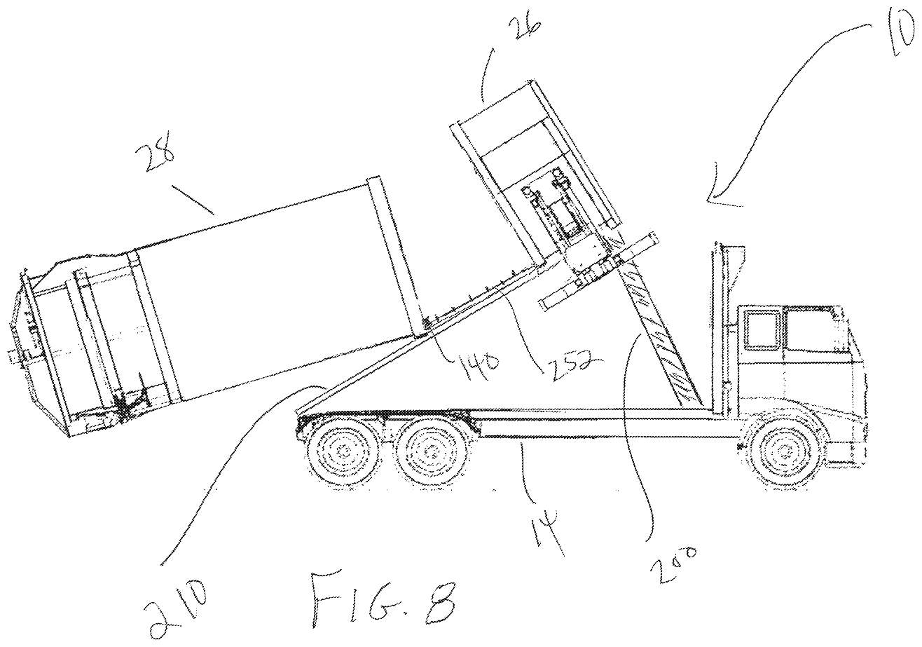

FIG. 9 shows another method of removal of full disposal container 428 from disposal truck 10. A flatbed truck, the rear portion 410 of which is shown is lined up with the rear face of disposal container 428 which has a hitching device 480 (similar to that shown in FIG. 3). The rear portion 410 of the flatbed truck is provided with a roll off frame 448 which is similar to and mirrors that shown in FIG. 7A. Roll off frame 448 has a hook 456 on cable 452, which is threaded through pulley 454 on roll off frame 448, with hook 456 being attached to hitching device 480 on disposal container 448. If ratchet chain binders are in use (to hold disposal container 428 and compacting unit 26 together), they are removed. When power to the hydraulic cylinders (not shown) in roll off frame 448 is turned on, cable 452 retracts into the roll off frame 448, pulling the full disposal container 448 (#1) off of the truck and onto roll off frame 448 as shown in FIG. 9. As soon as full disposal container 428 is removed, the truck can then be line up in front of empty disposal container 328, shown as #2 in FIG. 10, and then mounted on the truck in the same way as explained above with reference to FIG. 8.

Roll off frame 448 may also be provided with multiple hook and cable system so that more than one disposal container can be removed from disposal trucks. In this way, multiple disposal containers can be returned to the dump on one vehicle, emptied and returned to the same location where the unloading occurred, reducing the amount of time spent by the disposal truck in emptying its contents, increasing the amount of time dedicated to collecting trash and decreasing the amount of fuel used by decreasing the amount of return trips made to the dump.

Preferred embodiments of this invention are described herein including the best mode known to the inventors for carrying out the invention. Variations of or modifications to the preferred embodiments may become apparent to those of ordinary skill in the art upon reading the foregoing descriptions. It is intended that the following claims be interpreted to embrace all such variations and modifications.

What is claimed is:

1. A side loading disposal truck comprising:
a chassis with a cab and four or more wheels attached to the chassis;
a roll off frame attached to the chassis with a hydraulic ram and lever arrangement;
a compacting unit fixedly attached to the roll off frame;
a disposal container removably attached to the roll off frame and compacting unit;
the compacting unit including a hopper and a compacting blade arrangement having hydraulic cylinders attached to the blades;
a side loading arm operatively attached to the compacting unit, the side loading arm having a gripping mechanism for gripping a trash can;
the disposal container having hydraulic cylinders with cutting blades hydraulic cylinders;
wherein the compacting unit and disposal container have mating openings so that when they are fixedly mounted next to each other on the chassis and the truck is operated, the side loading arm repeatedly grips a residential can containing garbage and dumps the garbage into the hopper portion of the compacting unit; the compacting unit by way if its compacting blade arrangement pushes the trash through the hopper into the disposal container; the cutting blades of the disposal container are moved by way of the hydraulic cylinders in an up and down motion to further compact the garbage as it is moved into the interior of the container;
wherein once the disposal container is at least half full, the truck is driven to a predetermined location and after the cutting blades of the disposal container seal the opening of the container, the disposal container is unloaded by removing it from the roll off frame by way of the hydraulic ram and lever arrangement and an empty disposal container is loaded on to the roll off frame by way of the hydraulic ram and lever arrangement to replace the removed container.

2. The disposal truck of claim 1 wherein the disposal container and compacting unit are removably attached to each other with ratchet chain binders.

3. The disposal truck of claim 1 wherein the disposal container includes rails to keep it centered on the roll off frame and a hitching device to aid in loading and unloading the container.

4. The disposal truck of claim 1 wherein the disposal container has a drip edge extending along its width to prevent spillage of trash when the container is separated from the compacting unit.

5. A side loading disposal truck comprising:
a chassis with a cab and four or more wheels attached to the chassis;
a roll off frame attached to the chassis with a hydraulic ram and lever arrangement;
a compacting unit fixedly attached to the roll off frame;
a disposal container removably attached to the roll off frame and compacting unit;
the compacting unit including a hopper and a compacting blade arrangement having hydraulic cylinders attached to the blades;
a side loading arm operatively attached to the compacting unit, the side loading arm having a gripping mechanism for gripping a recycle bin;
the disposal container having hydraulic cylinders with cutting blades hydraulic cylinders;
wherein the compacting unit and disposal container have mating openings so that when they are fixedly mounted next to each other on the chassis and the truck is operated, the side loading arm repeatedly grips a residential bin containing recyclable material and dumps the recyclable material into the hopper portion of the compacting unit; the compacting unit by way if its compacting blade arrangement pushes the recyclable materials through the hopper into the disposal container; the cutting blades of the disposal container are moved by way of the hydraulic cylinders in an up and down motion to further compact the recycling material as it is moved into the interior of the container;
wherein once the disposal container is at least half full, the truck is driven to a predetermined location and after the cutting blades of the disposal container seal the opening of the container, the disposal container is unloaded by removing it from the roll off frame by way of the hydraulic ram and lever arrangement and an empty disposal container is loaded on to the roll off frame by way of the hydraulic ram and lever arrangement to replace the removed container.

6. The disposal truck of claim 5 wherein the disposal container and compacting unit are removably attached to each other with ratchet chain binders.

7. The disposal truck of claim 5 wherein the disposal container includes rails to keep it centered on the roll off frame and a hitching device to aid in loading and unloading the container.

8. The disposal truck of claim 5 wherein the disposal container has a drip edge extending along its width to prevent spillage of recyclable materials when the container is separated from the compacting unit.
